(19) United States
(12) Patent Application Publication
(10) Pub. No.: US 2019/0067967 A1
(43) Pub. Date: Feb. 28, 2019

(54) Cell phone charging station

(71) Applicant: Remi Chouinard, Jonquiere (CA)

(72) Inventor: Remi Chouinard, Jonquiere (CA)

(21) Appl. No.: 16/105,010

(22) Filed: Aug. 20, 2018

(30) Foreign Application Priority Data
Aug. 22, 2017 (GB) 1713489.1

(51) Int. Cl. H02J 7/00; H04M 1/06

(52) U.S. Cl. CPC H02J 7/0044; H02J 7/02; H04M 1/06

(57) ABSTRACT

A cell phone charging station is provided. It is a particular advantage of the cell phone charging station to be positioned at or near eye-level of a user. The cell phone charging station includes a support frame forming part of a body that is attached to a wall at a reasonable height so as to be easily visible and accessible without bending down or reaching up. The support frame has a cell phone compatible socket which connects to a charger. The charger is connected to house current. Preferably, that house current comes from a light switch located next the charging station. The support frame is configured so as to securely hold a cell phone therein.

### CROSS-REFERENCE TO RELATED APPLICATIONS

The present application claims priority to United Kingdom Patent Application serial number GB1713489 filed on Aug. 2, 2017 entitled “Cell phone charging station”, the disclosure of which is hereby incorporated in its entirety at least by reference.

### BACKGROUND OF THE INVENTION

### 1. Field of the Invention

The present invention relates generally to charging stations, but more particularly to a cell phone charging station.

### 2. Description of Related Art

Typically a charger is plugged into an AC power outlet and a long cable (USB cable for example) connects to the cell phone charger input. Often, people don't remember in which specific outlet they plugged in their charger. Sometimes, the connecting cable is very long and drags on the ground, gets tangled in with other wires and cables. There is also the matter of bending down to unplug the charger, and sometimes to pick up the phone on the ground. As well as forgetting which power outlet was used for plugging in the phone and therefore losing the phone as well. All this can be quite frustrating and messy.

Below are some inventions that have attempted to solve this issue, for example, U.S. Pat. No. 9,344,136 discloses a charging medium for a mobile phone. The media includes a support block, a power supply, and a charging stand. The support rests on a flat surface.

US patent application 2002/0176571 discloses a vertical support for a mobile phone which is connected to a source of electric power. The vertical support has a housing providing holding and recharging.

US application 2009/0047827 discloses a charging medium for an electrical device such as a mobile phone. The support takes the form of a tablet that supports a device. The unit is connected to an electric charging wire that is connected to the electrical power. The support tablet and the charging wire are retractable.

US application 2010/0285847 discloses a charging medium which can take various forms. The support is in particular embedded in any object. The support comprises in particular a power supply which is connected to the electric current and a charging connection.

US application 2015/0263447 discloses a charging medium for a mobile phone. The support may in particular be partially embedded in the wall and be connected to an electrical outlet. The support is notably equipped with a power supply unit and a charging socket, and several versions of the invention are presented in the patent.

One of the main drawback of the prior art is that some are quite elaborate and potentially costly to manufacture. Further, they generally get their power directly from an AC outlet which is often located about a foot above the floor, which makes the charging station less visible and harder to reach. Consequently, there is a need for a cell phone charging station that solves the a fore mentioned problems.

### BRIEF SUMMARY OF THE INVENTION

In one embodiment of the present invention a cell phone charging station is provided, comprising a body member having a compartment configured to retain a charging circuit and a connector interface, wherein a back side of the body member is configured to attach to a wall at a user's eye-level; a compatible socket configured to attach to the connector interface, wherein the compatible socket has a connection configured to connect with a cell phone charging port of a cell phone; and, wires connected to the charging circuit, the wires configured to connect to an alternating current home current.

In one embodiment, the compartment protrudes from the body member such that the cell phone charging station is L-shaped, and the cell phone is configured to rest securely on the L-shaped cell phone charging station. In one embodiment, the compartment includes a receptacle configured to hold the compatible socket. In another embodiment, the receptacle is positioned in a top portion of the compartment such that the connection of the compatible socket is exposed outside of the compartment. In one embodiment, the wires are configured to exit an opening in a back portion of the compartment. In one embodiment, the body member is configured to attach to the wall via mechanical fasteners. In another embodiment, the compartment is closed with a cover via a mechanical fastener of the mechanical fasteners. In yet another embodiment, the body member is configured to attach to the wall via adhesive bonds on the back side of the body member.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an exploded view of a cell phone charging station according to an embodiment of the present invention;

FIGS. 2A-B are isometric views of a cell phone charging station according to an embodiment of the present invention; and,

FIGS. 3A-C are side and front view respectively of a cell phone charging station installed on a wall according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a cell phone charging station.

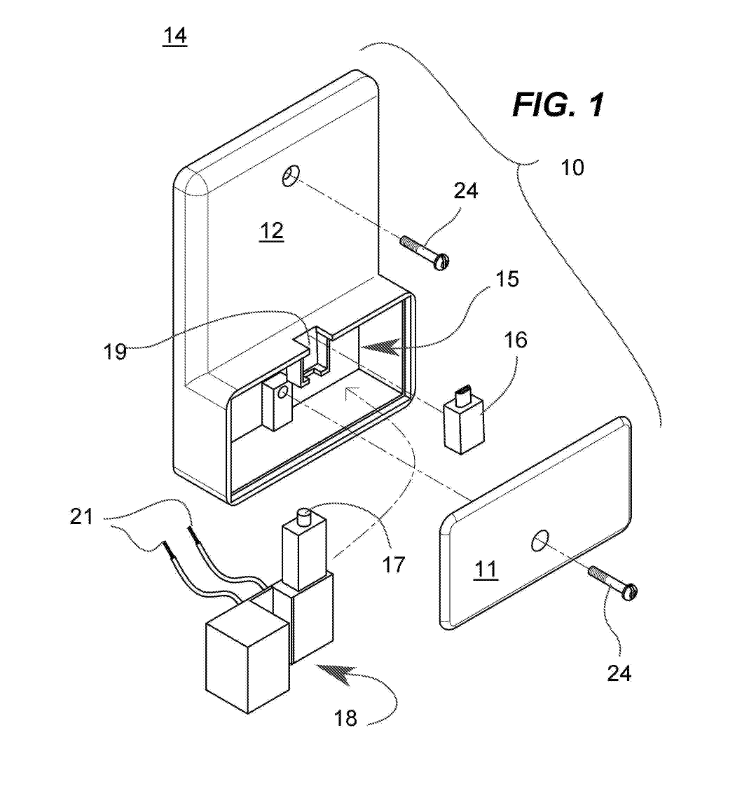

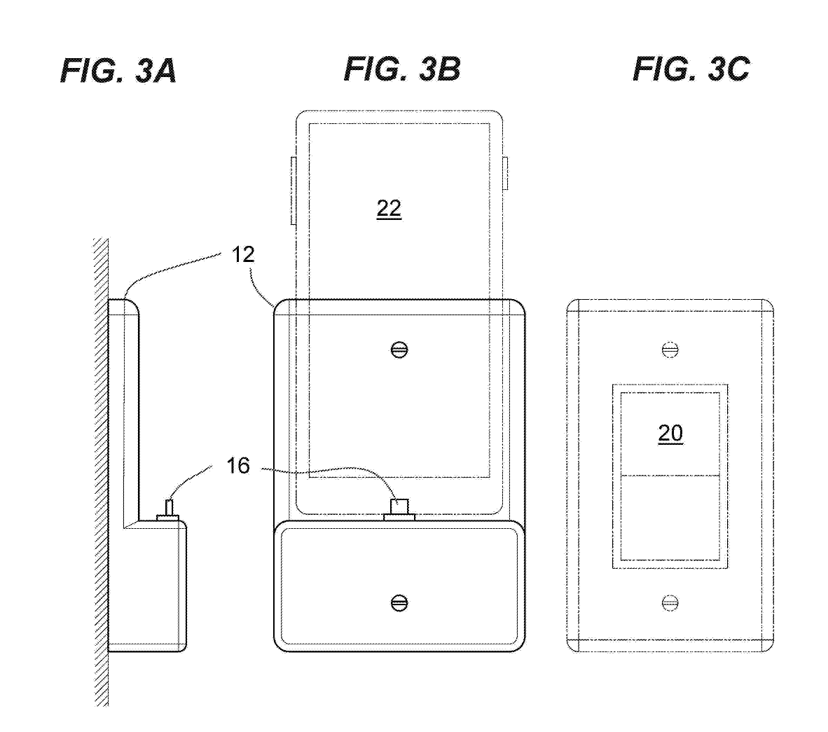

Referring now to any of the accompanying FIGS. 1-3, a cell phone charging station 10 is illustrated. The cell phone charging station comprises a body 12 configured to be mechanically fastened to a wall 14 via a mechanical fastener 24 or adhesive bands 26. It is a particular advantage of the present invention to be installed at a reasonable height, such that the cell phone charging station may be easily accessible without bending down or reaching up. For instance, the cell phone charging station may be installed at a user's eye-level.

In one embodiment, the body includes a compartment 15 configured to hold charging circuit 18. The charging circuit includes an internal circuit (not shown), a connector interface 17, and wires 21. The internal circuit may be any battery charger circuit known in the art, such as a lithium-ion battery charging circuit as well known in the art. In one embodiment, the connector interface is configured to connect with a compatible socket 16, wherein the compatible socket has a connection corresponding to a specific cell phone. For instance, the connection may be an Apple® reversible lightning connector, a micro-USB, or USB Type C connector depending on which cell phone is desired to be charged. In one embodiment, the compatible socket may be changed depending on the cell phone used. Other connections may be present that are not listed above, such as other cell phone or smart phone connections.

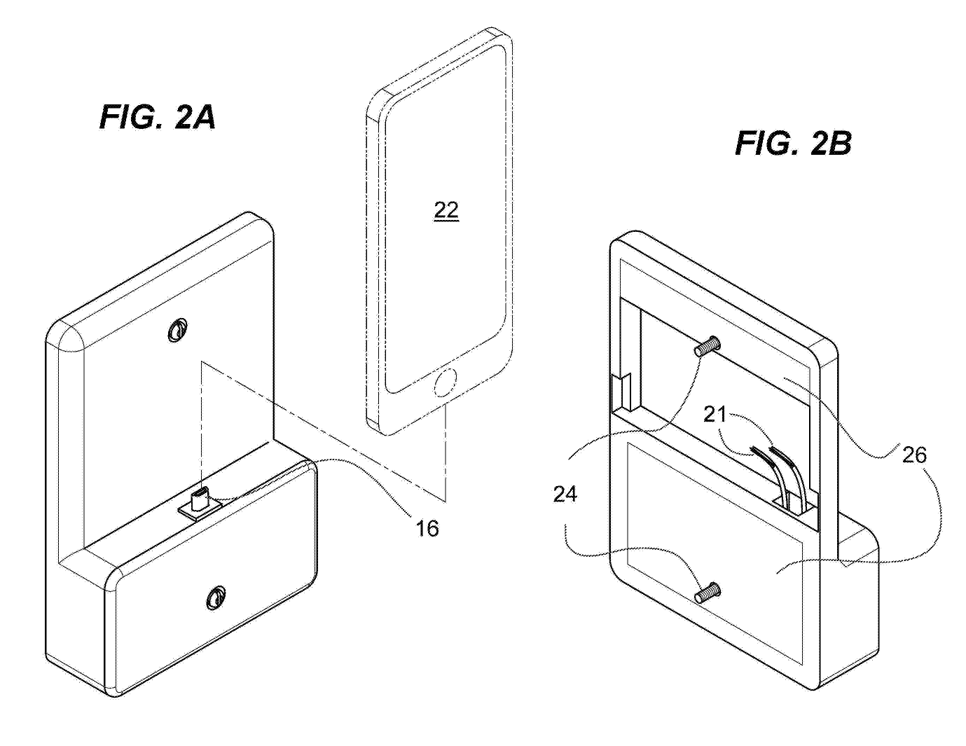

In one embodiment, the wires (live and neutral) connect to the internal current in the house, which may connect to switch wires (not shown) from a switch 20, such as a light switch. In this way, the cell phone charging station can easily connect to the house current via the switch wires. In one embodiment, wires 21 are configured to exit the assembly in a back portion of the compartment (best seen in FIG. 2B). In one embodiment, the wires connect to the switch wires (not shown) by chiseling the wall so that they can pass from behind the body and under the plate cover of the switch. Alternatively, the body can be connected an electrical box (not shown) via mechanical fasteners, such as an electrical double box, which could also take the switch. When an electrical box is not possible and no holes want to be made in the wall, attachment to the wall can be made by way of adhesive bands as previously described.

In one embodiment, a top portion of the compartment includes a receptacle 19 configured to hold the compatible socket. The compartment is closed via cover 11 with a mechanical fastener 24.

It is a particular advantage of the present invention, in which the rectangular shaped body 12 and rectangular compartment 15 which protrudes from the body combine to form an L-shape configured to securely hold a cell phone 22, such as a smart phone.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

What is claimed is:

1. A cell phone charging station comprising:
a body member having a compartment configured to retain a charging circuit and a connector interface, wherein a back side of the body member is configured to attach to a wall at a user's eye-level;
a compatible socket configured to attach to the connector interface, wherein the compatible socket has a connection configured to connect with a cell phone charging port of a cell phone;
wires connected to the charging circuit, the wires configured to connect to an alternating current home current; the compartment protrudes from the body member such that the cell phone charging station is L-shaped, and the cell phone is configured to rest securely on the L-shaped cell phone charging station; the receptacle is positioned in a top portion of the compartment such that the connection of the compatible socket is exposed outside of the compartment.

2. (canceled)

3. The cell phone charging station of claim 1, wherein the compartment includes a receptacle configured to hold the compatible socket.

4. (canceled)

5. The cell phone charging station of claim 1, wherein the wires are configured to exit an opening in a back portion of the compartment.

6. The cell phone charging station of claim 1, wherein the body member is configured to attach to the wall via mechanical fasteners.

7. The cell phone charging station of claim 6, wherein the compartment is closed with a cover via a mechanical fastener.

8. The cell phone charging station of claim 1, wherein the body member is configured to attach to the wall via adhesive bonds on the back side of the body member.
